(19) United States
(12) Patent Application Publication
(10) Pub. No.: US 2018/0216448 A1
(43) Pub. Date: Aug. 2, 2018

(54) MOTOR PROTECTOR OF AN ELECTRIC SUBMERSIBLE PUMP AND AN ASSOCIATED METHOD THEREOF

(71) Applicant: General Electric Company, Schenectady, NY (US)

(72) Inventors: Jose Luiz Bittencourt, Rio de Janeiro (BR); Rafael Horschutz Nemoto, Rio de Janeiro (BR); Luis Francisco Baieli, Comodoro Rivadavia (AR); Henrique Moritz, Rio de Janeiro (BR)

(21) Appl. No.: 15/421,843

(22) Filed: Feb. 1, 2017

(51) Int. Cl. E21B 43/12; F04D 13/08; F04D 13/06; F04D 1/06; F04D 29/42; F04D 29/041; F04D 29/043; F04D 29/10; H02K 5/132; H02K 5/16; H02K 5/22

(52) U.S. Cl. CPC E21B 43/128; F04D 13/086; F04D 13/0693; F04D 1/06; F04D 29/426; H02K 5/225; F04D 29/043; F04D 29/106; H02K 5/132; H02K 5/163; F04D 29/041

(57) ABSTRACT

A motor protector includes a housing and a rotatable shaft disposed within the housing and a plurality of radial bearings coupled to the rotatable shaft, for supporting the rotatable shaft against the housing. The motor protector further includes a thrust bearing coupled to the rotatable shaft, for supporting the rotatable shaft against the housing. The motor protector also includes a shaft seal coupled to the rotatable shaft, and configured to seal a first portion from a second portion of the housing. The motor protector also includes an isolation chamber, coupled substantially lateral to the housing and configured to separate a first fluid and a second fluid via the housing.

### BACKGROUND

Embodiments of the present invention relate generally to electric submersible pumps (ESPs), and more particularly to a motor protector of an electric submersible pump and an associated method thereof.

Conventionally, subterranean areas of interest are accessed through a borehole. The borehole is surrounded by subterranean material such as sand that may migrate out of the borehole along with oil, gas, water, and/or other fluid generated from a well. An outermost casing is inserted in the borehole and held in position using cement in the space between an outer surface of the casing and surrounding earth. The fluid produced from the well flows to earth's surface through a production tubing. A variety of fluid lifting systems may be used to pump the fluid from the wellbore to earth's surface. For example, an electric submersible pump (ESP) having a pump, a motor, and a motor protector between the motor and the pump, is disposed in the wellbore for extracting the fluid. The motor protector is used to protect the motor from contamination by the extracted fluid. Further, the motor protector is also used to protect the motor from other contaminants such as particulate solids and other debris. The electric submersible pump disposed in wellbore is constrained by lateral space limitations.

Recently, ESPs have been employed on the sea floor for boosting subsea production. The low cost of ESPs compared to multiphase subsea pumps has driven increased deployment of ESPs horizontally (or slightly inclined) on skids that are laid on mudlines although ESPs are originally designed for downhole applications. The mudline ESP, also known as ESP on the skid, basically includes a conventional ESP installed in a capsule, which emulates the well production casing. Such use of ESPs facilitates to increase fluid production while reducing downtime during interventions. If an ESP located outside the production well, undergoes failure/repair, the operator is able to continue production, using backup artificial lift systems (e.g. gas lift systems). One drawback of using an ESP for such an application is larger length. Longer ESP strings demand bigger vessels during intervention operations and are more complex to handle.

### BRIEF DESCRIPTION [TO BE COMPLETED LATER]

In accordance with one aspect of the invention, a motor protector is disclosed. The motor protector includes a housing and a rotatable shaft disposed within the housing and a plurality of radial bearings coupled to the rotatable shaft, for supporting the rotatable shaft against the housing. The motor protector further includes a thrust bearing coupled to the rotatable shaft, for supporting the rotatable shaft against the housing. The motor protector also includes a shaft seal coupled to the rotatable shaft, and configured to seal a first portion from a second portion of the housing. The motor protector also includes an isolation chamber, coupled substantially lateral to the housing and configured to separate a first fluid and a second fluid via the housing.

In accordance with one aspect of the invention, an electric submersible pump is disclosed. The electric submersible pump includes a motor protector having a housing and a rotatable shaft mounted within the housing. The motor protector further includes a plurality of radial bearings coupled to the rotatable shaft, for supporting the rotatable shaft against the housing. The motor protector also includes a thrust bearing coupled to the rotatable shaft, for supporting the rotatable shaft against the housing. Further, the motor protector includes a shaft seal coupled to the rotatable shaft, and configured to seal a first portion from a second portion of the housing. The motor protector also includes an isolation chamber coupled substantially lateral to the housing. The electric submersible pump further includes a motor coupled to a first portion of the rotatable shaft. The electric submersible pump also includes a pump unit coupled to a second portion of the rotatable shaft. The isolation chamber is configured to separate a wellbore fluid extracted form a wellbore, from motor oil received via the housing.

### DRAWINGS

These and other features and aspects of embodiments of the present invention will become better understood when the following detailed description is read with reference to the accompanying drawings in which like characters represent like parts throughout the drawings, wherein:

FIG. 1 is a schematic illustration of a subsea production system having an electric submersible pump for extraction of a first fluid, for example, a wellbore fluid in accordance with an exemplary embodiment;

FIG. 2 is a side view of an electric submersible pump having a motor protector in accordance with an exemplary embodiment;

FIG. 3 is a schematic cross sectional view of a motor protector in accordance with an exemplary embodiment;

FIG. 4 is a schematic illustration of a labyrinth chamber of a motor protector in accordance with an exemplary embodiment;

FIG. 5 is a schematic illustration of a bag chamber of a motor protector in accordance with an exemplary embodiment;

FIG. 6 is a schematic illustration of a metal bellow chamber of a motor protector in accordance with an exemplary embodiment;

FIG. 7 is a perspective view of a motor protector having a plurality of seal chambers in series arrangement in accordance with an exemplary embodiment;

FIG. 8 is a perspective view of a motor protector having a plurality of seal chambers in parallel arrangement in accordance with an exemplary embodiment; and

FIG. 9 is a flow chart of a method for operating an electric submersible pump in accordance with an exemplary embodiment.

### DETAILED DESCRIPTION

As will be described in detail hereinafter, embodiments of a system and method for protecting an electric motor of an electric submersible pump (ESP) are disclosed. A motor protector of the electric submersible pump is used for protecting an electric motor of the ESP. The motor protector includes a housing, a rotatable shaft supported by a plurality of radial bearings inside the housing, and a thrust bearing coupled to the rotatable shaft. The motor protector further includes one or more shaft seals disposed along the rotatable shaft, between a pump unit and the electric motor. An isolation chamber is coupled substantially lateral to the housing and configured to control a pressure difference between an extracted first fluid, for example, a wellbore fluid and a second fluid, example, motor oil and thereby ensure control of the pressure exerted on the shaft seals.

The exemplary motor protector disclosed herein includes a suction chamber which is configured to perform combined functions performed by a motor protector and a pump intake of a conventional ESP. The exemplary motor protector has a reduced length and enables use of the ESP without encapsulation on the mudline. The shaft seals of the motor protector are used to isolate and protect the motor from the first fluid. The isolation chamber is configured to equalize the pressure between the first fluid and second fluid and thereby allow thermal expansion of the second fluid. The thrust bearings are configured to absorb shaft thrust generated by the pump unit. The rotatable shaft is configured to transmit a torque generated by the motor to the pump unit.

When ESPs are employed on the subsea mudline (i.e. outside the wellbore), outer diameter of the ESP is no longer a hard constraint. A feasible way to reduce the string length is to make more use of the available lateral space. In accordance with the disclosed exemplary embodiments, the isolation chamber is disposed lateral to the housing, thereby reducing length of the ESP. Short ESPs can significantly reduce operation costs, because such ESPs can be easily handled by smaller vessels.

The term ‘subsea’ refers to a region below the sea surface and includes sea-bed and wells drilled downwards from the sea-bed. Apparatus, components, and systems used for extracting wellbore fluids, installed on the seabed and in a wellbore, may be referred to as a ‘subsea production system’.

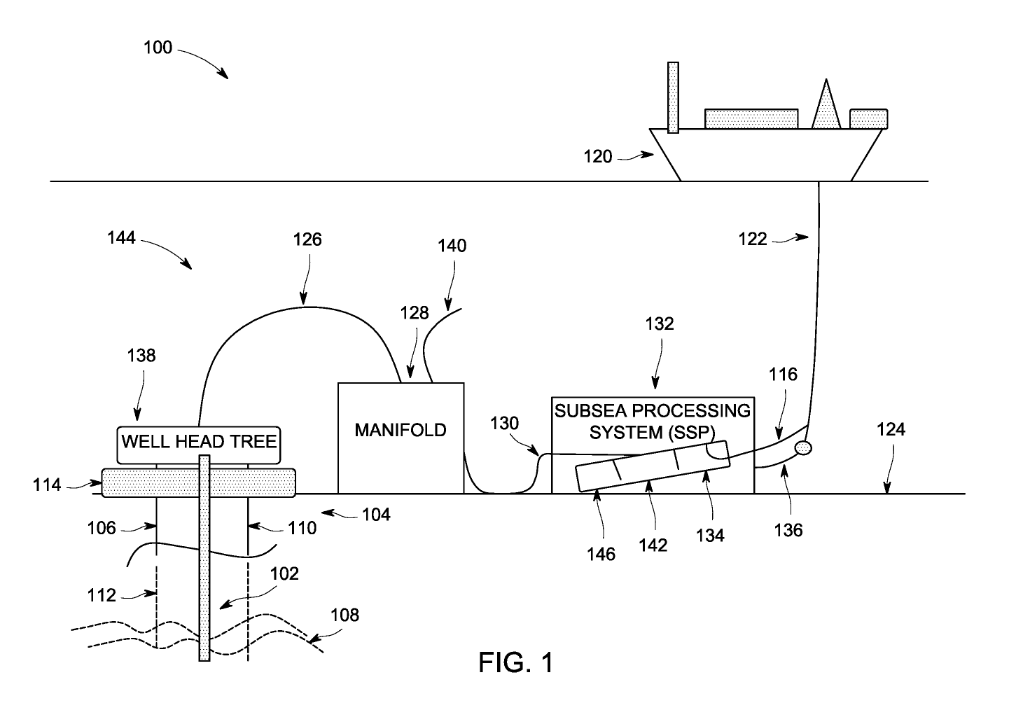

FIG. 1 is a diagrammatic illustration of a subsea production system 100 used for extraction of a first fluid, for example, a wellbore fluid in accordance with an exemplary embodiment. The subsea production system 100 includes a production unit 120 disposed on a vessel or a fixed platform or onshore. The production unit 120 is coupled to a riser system 122 and configured to receive the first fluid from subsea 144 through the riser system 122. The riser system 122 is coupled to a flow line 136 and configured to receive the first fluid from a flow line 136. Although the riser system 122 shown in the illustrated embodiment, is a single riser system, in other embodiments, a plurality of riser systems may be used. The flow line 136 is coupled to a subsea processing system 132 having the ESP 134 and configured to receive the wellbore fluid from the ESP 134. The subsea production system 100 further includes a manifold 128 coupled to a plurality wells through a plurality of respective well jumpers 126, 140. The well jumper 126 is used to transfer the first fluid from the well 104 to the manifold 128. For the ease of illustration, in the illustrated embodiment, only one well 104 is shown. The first fluid from another well is transferred to the manifold 128 through the well jumpers140. The manifold 128 is configured to control, distribute, and monitor flow of the first fluid. The subsea production system 100 further includes a well head tree 138 used to couple a well head 114 to the well jumper 126. The well head tree 138 is configured to control the flow of the first fluid from the well 104.

The well 104 includes a wellbore 106 drilled into a geological formation 108 having the first fluid, including but not limited to, petroleum and shale gas. The well 104 further includes a casing 110 disposed in the wellbore 106. The casing 110 includes a plurality of perforations 112 to enable flow of the first fluid from the geological formation 108 to the wellbore 106. A production tubing 102 is provided within the wellbore 106 to transport the first fluid outwards from the wellbore 106. A power cable 116, for example, an umbilical cable, is provided through the riser system 122 to supply electric power to a ESP 134 disposed on a seabed 124. In another embodiment, the power cable 116 may be disposed outside the riser system 122 and insulated from the subsea surroundings. In such an embodiment, the power cable 116 is connected to the production unit 120. The ESP 134 is used to pump the first fluid from the geological formation 108 via the wellbore 106. In some embodiments, other related equipment such as piping and valves may be coupled to the production unit 120 to distribute and control flow of the extracted first fluid from the geological formation 108 of the wellbore 106.

In one embodiment, the ESP 134 is disposed horizontally on the seabed 124 and directly in contact with sea water. In another embodiment, the ESP 134 is mounted at an inclined position depending on skid dimensions. The ESP 134 includes a motor protector 142 configured to protect an electric motor 146. The exemplary ESP 134 is disposed outside the wellbore 106 and has a shorter length.

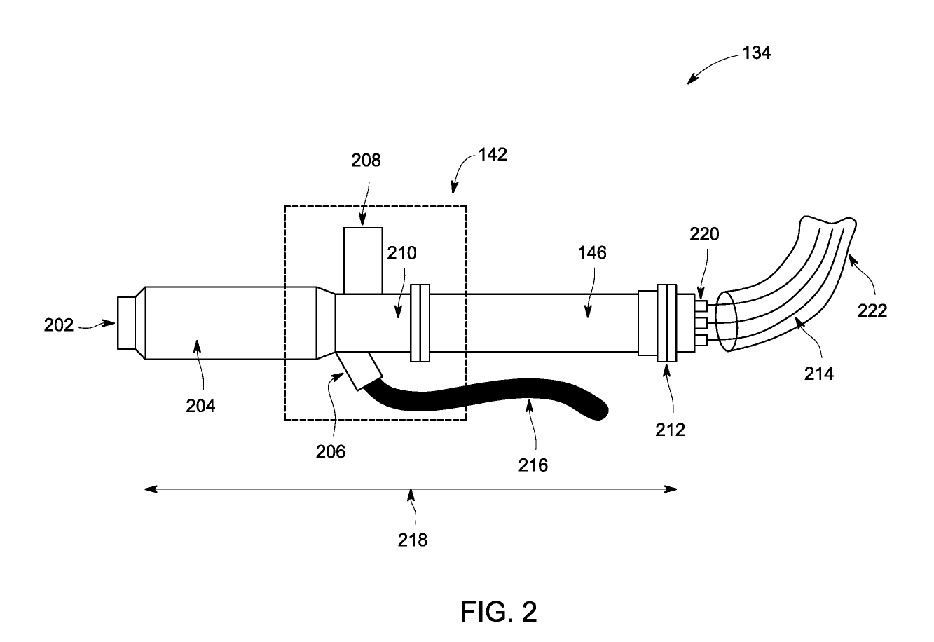

FIG. 2 is a side view of the ESP 134 having the motor protector 142 in accordance with an exemplary embodiment. In the illustrated embodiment, the ESP 134 includes a discharge head 202, a pump unit 204, the motor protector 142, the electric motor 146, and a pothead 212. The motor protector 142 is disposed between the electric motor 146 and the pump unit 204. The discharge head 202 connects the pump unit 204 to a production tubing of the riser system 122 shown in FIG. 1. In one embodiment, the discharge head may be connected to the flowline 136.

One end of the pump unit 204 is coupled to the discharge head 202. Another end of the pump unit 204 is coupled to an end of the motor protector 142. One end of the electric motor 146 is coupled to another end of the motor protector 142. The pothead 212 is coupled to another end of the motor 146. The pothead 212 is configured to withstand a difference between the second fluid pressure and external hydrostatic pressure generated due to depth of seawater. As a result, seawater incursion into the motor 146 and leakage of the second fluid to the surrounding sea water can be avoided. The pothead 212 further includes a plurality of metal contacts 220 for coupling a plurality of electric cables 214 to the motor 146. The plurality of electric cables 214 is encapsulated to provide protection from subsea water. In one embodiment, the plurality of electric cables 214 is encapsulated using a capsule 222. Further, the electric motor 146 is coupled to the pump unit 204 via a rotatable shaft (not shown in FIG. 2) of the motor protector 142. The pump unit 204 is driven by the electric motor 146. The motor protector 142 is configured to isolate the electric motor 146 from the pump unit 204, thereby ensuring protection of the electric motor 146 from the first fluid which usually has particulate solids and other debris from the geological formation.

In one embodiment, the pump unit 204 is a multistage centrifugal type pump unit. The pump unit 204 is configured to impose kinetic energy to the first fluid by centrifugal force and then convert the kinetic energy to a potential energy in the form of pressure. The pump unit 204 includes a plurality of impellers (not shown) configured to receive rotary motion generated by the electric motor 146 through the rotatable shaft.

In accordance with the embodiment of the present invention, the motor protector 142 is configured to protect the electric motor 146 by providing an isolation between the electric motor 146 and the pump unit 204. The motor protector 142 includes a housing 210, an isolation chamber 208 coupled substantially lateral to the housing 210, and a first inlet 206 coupled to the housing 210. Specifically, the isolation chamber 208 is coupled substantially orthogonal to the housing 210 disposed horizontally on the seabed. In certain embodiments where the housing 210 is disposed at an inclination from the seabed, the isolation chamber 208 is coupled to the housing 210 such that the isolation chamber 208 is disposed along a vertical direction substantially with respect to the seabed. The motor protector 142 is configured to equalize the pressure of first fluid in a suction chamber (not shown in FIG. 2) with the pressure of the second fluid of the electric motor 146. In one embodiment, the isolation chamber 208 is a labyrinth chamber configured to equalize a pressure of second fluid with a pressure of the first fluid. In another embodiment, the isolation chamber 208 is a bag chamber configured to equalize a pressure of the second fluid with a pressure of the first fluid. In yet another embodiment, the isolation chamber 208 is a metal bellow chamber configured to equalize a pressure of the second fluid with a pressure of the first fluid. In yet another embodiment, a plurality of such chambers 208 may be used in series or parallel configurations to equalize a pressure of the second fluid with a pressure of the first fluid. The isolation chamber 208 is configured to accommodate variations in volume of the second fluid due to expansion and contraction. One end of the first inlet 206 is coupled to the housing 210 of the motor protector 142 and another end of the first inlet 206 is coupled to the flowline 130 (shown in FIG. 1).

In one embodiment, the electric motor 146 is driven by a high voltage alternating current source. For example, the high voltage source may be a 5 kV voltage source. The electric motor 146 may be operated at a temperature of 500 degree Fahrenheit, for example. In certain embodiments, the electric motor 146 may be operated at a pressure of about 5000 psi at an operating depth of 15,000 feet. In one embodiment, the electric motor 146 is two-pole, squirrel cage induction electric motor. In another embodiment, the electric motor 146 is a permanent magnet synchronous motor. The sea water surrounding the ESP 134 is used for cooling the electric motor 146.

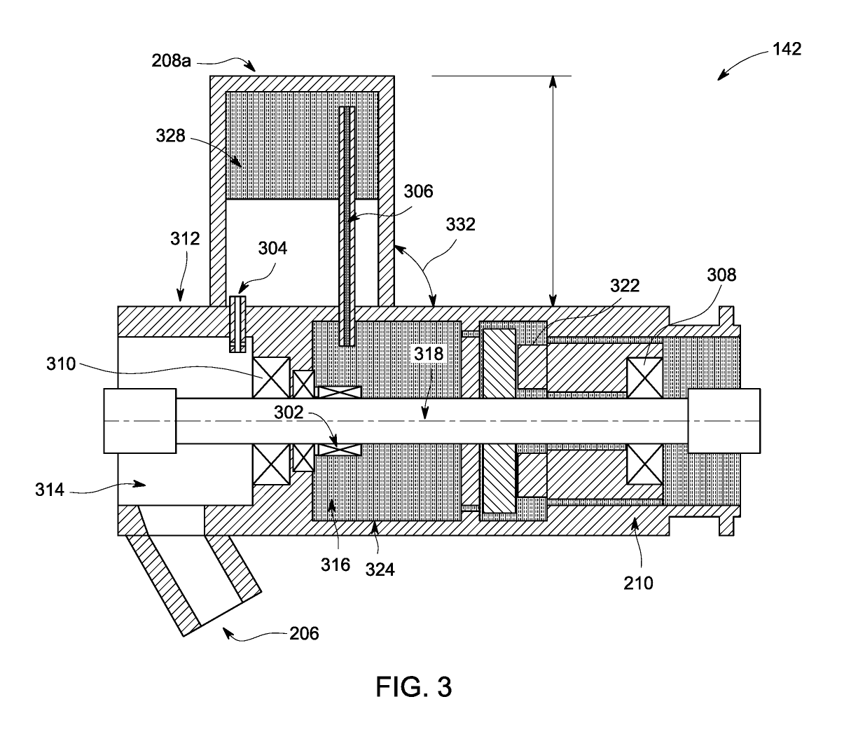

FIG. 3 is a schematic cross section view of the motor protector 142 in accordance with an exemplary embodiment. The motor protector 142 includes the housing 210 and a rotatable shaft 318 disposed within the housing 210. A suction chamber 312 within the housing 210, is used for storing the first fluid 314. Further, a container 324 disposed within the housing 210, is used for storing the second fluid 316. The suction chamber 312 is configured to receive the first fluid 314 from the wellbore through the flowline 216. The first fluid 314 is transferred from the suction chamber 312 to a first stage of the pump unit. The container 324 is configured to receive the second fluid 316 from the motor. A plurality of radial bearings 308, 310 is coupled to the rotatable shaft 318 and used for supporting the rotatable shaft 318 against the housing 210. Further, a thrust bearing 322 is coupled to the rotatable shaft 318 and used for supporting the rotatable shaft 318 against the housing 210. A shaft seal 302 is coupled to the rotatable shaft 318 and configured to prevent fluidic communication between the suction chamber 312 having the first fluid 314 and the container 324 having the second fluid 316.

A labyrinth chamber 208a is coupled substantially orthogonal to the housing 210. In the illustrated embodiment, the first fluid 314 has a higher density compared to the second fluid 316. The labyrinth chamber 208a is configured to separate the first fluid 314 from the second fluid 316 under influence of gravity. The first fluid 314 contacts the second fluid 316 at an interface layer 328. The labyrinth chamber 208a facilitates to equalize pressure between the first fluid 314 and the second fluid 316 to accommodate expansion and contraction of the second fluid 316.

The first inlet 206 is coupled to the housing 210 for allowing flow of the first fluid 314 to the suction chamber 312. The motor protector 142 further includes a second inlet 304 extending from the suction chamber 312 to the labyrinth chamber 208a, for allowing flow of the first fluid 314 from the suction chamber 312 to the labyrinth chamber 208a. The motor protector 142 further includes a third inlet 306 extending from the container 324 to the labyrinth chamber 208a, for allowing flow of the second fluid 316 from the container 324 to the labyrinth chamber 208a. In the illustrated embodiment, the second inlet 304 and the third inlet 306 extend inward from a bottom side of the labyrinth chamber 208a. In another embodiment, the second fluid 316 may include, but not limited to, mineral oil, synthetic oil such as poly-alpha-olefin, and the like.

The radial bearing 310 is referred to as a pump side radial bearing and the radial bearing 308 is referred to as the motor side radial bearing. In one embodiment, the radial bearing 308 includes a rolling-element bearing. The thrust bearing 322 is configured to limit transmission of a thrust load from the pump unit to the motor during operation of the ESP.

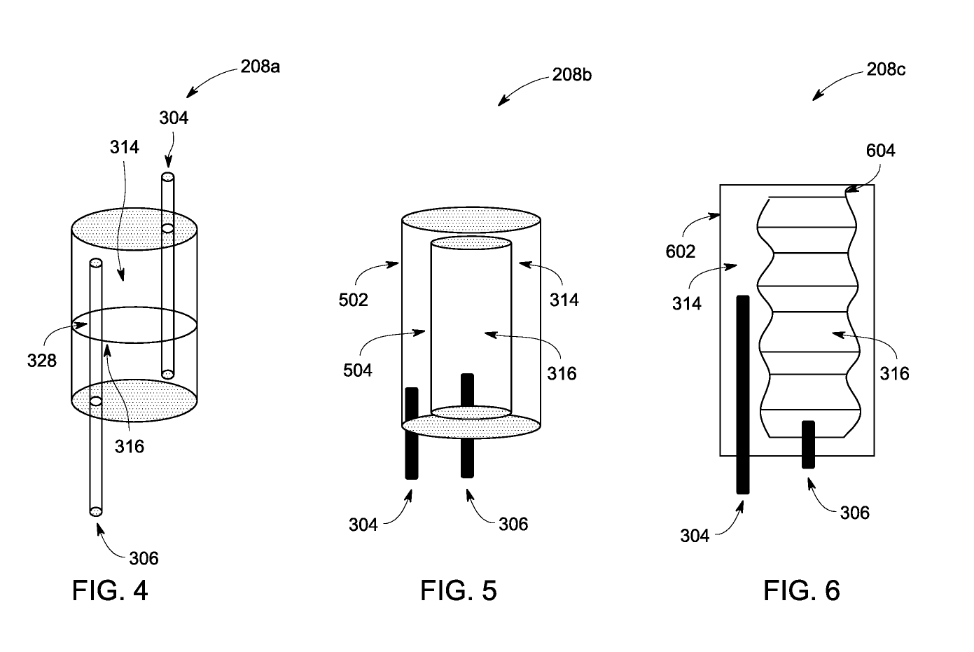

FIG. 4 is a schematic illustration of a labyrinth chamber 208a of a motor protector in accordance with another exemplary embodiment. The labyrinth chamber 208a is configured to receive the first fluid 314 from the second inlet 304 and the second fluid 316 from the third inlet 306. In the illustrated embodiment, the second inlet 304 extends inwards from a top side of the labyrinth chamber 208a and the third inlet 306 extend inwards from the bottom side of the labyrinth chamber 208a. In certain other embodiments, the second inlet 304 and the third inlet 306 extend inward from sides of the labyrinth chamber 208a. All such permutations and combinations of arrangement of the second and third inlets 304, 306 are envisioned. In such embodiments, the second inlet 304 permits flow of a denser fluid to the bottom portion of the labyrinth chamber 208a and the third inlet 306 permits flow of a lighter fluid to the top portion of the labyrinth chamber 208a.

FIG. 5 is a schematic illustration of a bag chamber 208b of a motor protector in accordance with another exemplary embodiment. The bag chamber 208b includes a first bag 502 and a second bag 504 coupled to the second inlet 304 and the third inlet 306 respectively. The first bag 502 and the second bag 504 may be made of different materials depending on the application. In one embodiment, the first bag 502 serves as a housing made of a rigid material which is not deformable due to fluid pressure. The second bag 504 may be made of an elastomer. In some embodiments, the second bag 504 may be made of carbon dioxide and hydrogen sulfide resistant elastomers. In the illustrated embodiment, the first bag 502 is used to contain the first fluid 314 and the second bag 504 is used to contain the second fluid 316. In one embodiment, the bag chamber 208b includes only one bag disposed in a fixed enclosure. In an embodiment where only one bag is used, the first fluid 314 is accumulated outside the bag and the second fluid 316 is accumulated inside the bag.

FIG. 6 is a schematic illustration of a metal bellow chamber 208c of a motor protector in accordance with another exemplary embodiment. The metal bellow chamber 208c includes a rigid housing 602 and a bellow housing 604 disposed within the rigid housing 602. The bellow housing 604 is a flexible vessel made up of a plurality of metals and alloys such as, but not limited to, brass, titanium and nickel. In one embodiment, the bellow housing 604 is cylindrical shaped. The bellow housing 604 is coupled to the third inlet 306 and used to contain the second fluid 316. The rigid housing 602 is coupled to the second inlet 304 and used to contain the first fluid 314.

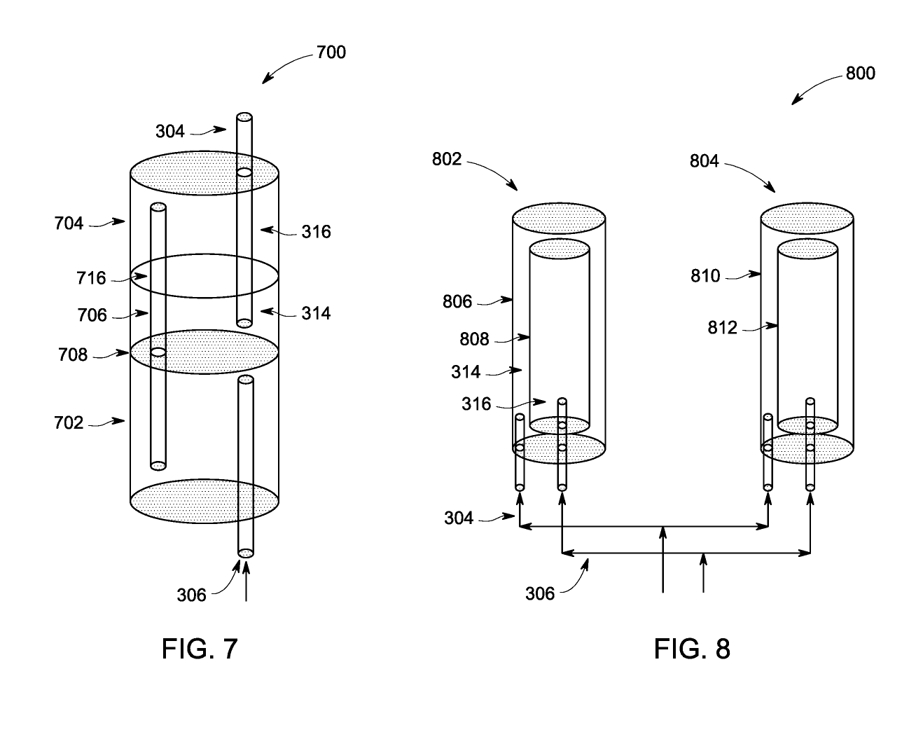

FIG. 7 is a perspective view of a motor protector 700 in accordance with another exemplary embodiment. In the illustrated embodiment, the motor protector 700 includes a first labyrinth chamber 702 and a second labyrinth chamber 704 connected to each other in series. In one embodiment, the first labyrinth chamber 702 and the second labyrinth chamber 704 are separated by a barrier 708. The first labyrinth chamber 702 is coupled to the third inlet 306 and configured to receive the second fluid 316. The second labyrinth chamber 704 is coupled to the second inlet 304 and configured to receive the first fluid 314. The first labyrinth chamber 702 and the second labyrinth chamber 704 are in fluidic communication with each other through a tubular path 706. The tubular path 706 is used to introduce the second fluid 316 from the first labyrinth chamber 702 into the second labyrinth chamber 704. The second inlet 304 introduces the first fluid 314 from the suction chamber into the second labyrinth chamber 704.

The first fluid 314 from the second labyrinth chamber 704 and the second fluid 316 from the second labyrinth chamber 704 contact each other to form an interface 716. When the second fluid 316 contracts, some portion of the second fluid 316 above the interface 716 recedes to the first labyrinth chamber 702 through the tubular path 706. Remaining portion of the second fluid 316 in the second labyrinth chamber 704 remains in contact with the first fluid 314. During normal operation, the second fluid 316 expands due to increase in temperature. The expanded second fluid 316 is allowed to enter the first labyrinth chamber 702. During shutdown operation, the second fluid 316 shrinks due to cooling and thereby, the second fluid 316 is withdrawn from the first labyrinth chamber 702.

FIG. 8 is a perspective view of a motor protector 800 in accordance with another exemplary embodiment. In the illustrated embodiment, the motor protector 800 includes a first bag 802 and a second bag 804 arranged in a parallel configuration. The first bag 802 includes an outer housing 806 configured to receive the first fluid 314 via the second inlet 304 and an inner bag 808 configured to receive the second fluid 316 via the third inlet 306. The second bag 804 includes an outer housing 810 configured to receive the first fluid 314 via the second inlet 304 and an inner bag 812 configured to receive the second fluid 316 via the third inlet 306. The parallel configuration of the first bag 802 and the second bag 804 provides sufficient volume for allowing expansion of the second fluid 316. In alternative embodiments, a motor protector having the bag chamber 208b disposed in parallel with the labyrinth chamber 208a and/or the metal bellow chamber 208c.

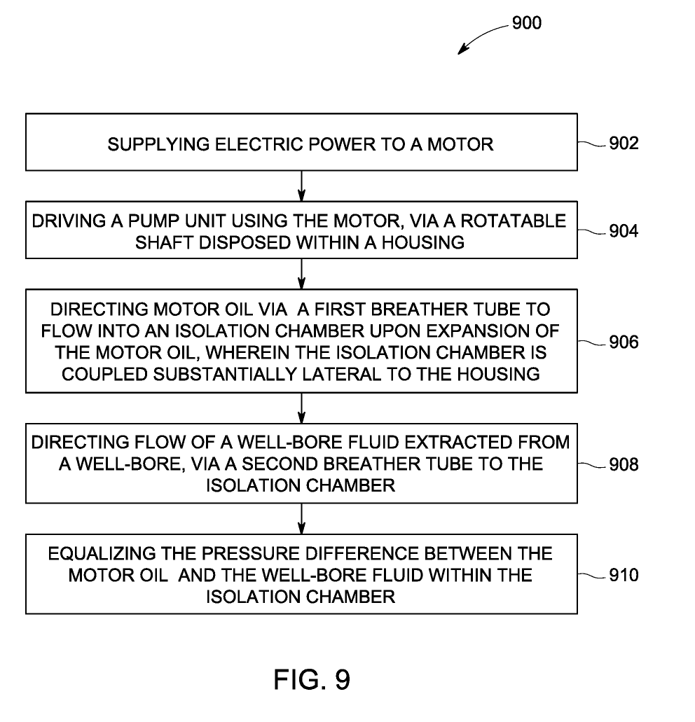

FIG. 9 is a flow chart of a method 900 for operating an ESP disposed on a subsea floor in accordance with an exemplary embodiment. The method 900 includes supplying electric power to a motor at step 902 and driving a pump unit using the motor via a rotatable shaft disposed within a housing of a motor protector at step 904. The pump unit operates to extract a first fluid, for example, a wellbore fluid. The motor is lubricated by a second fluid, for example, motor oil.

In step 906, the method further includes directing flow of the second fluid into the isolation chamber upon expansion of the second fluid. Similarly, the method 900 includes, at step 908, directing flow of the first fluid extracted from the wellbore, to the isolation chamber. The method 900 also includes separating the second fluid from the first fluid within the isolation chamber at step 910. If a labyrinth chamber is used as the isolation chamber, the separation of the second fluid from the first fluid is achieved under influence of gravity. If a bag chamber or a metal bellow chamber is used, the second fluid is separated from the first fluid using bags or bellows. In one embodiment, the method 900 further includes removing the second fluid from the isolation chamber via the housing upon contraction of the second fluid. As a result, a pressure difference between the first fluid and the second fluid is equalized. In another embodiment, the method 900 also includes preventing contact of the first fluid with the motor, along the rotatable shaft, using a shaft seal coupled to the rotatable shaft. In one embodiment, the method 900 includes limiting transmission of a thrust load from the pump unit to the motor, using a thrust bearing coupled to the rotatable shaft. In accordance with the embodiments discussed herein, the ESP has a shorter length because the isolation chamber is disposed in a lateral position.

It is to be understood that not necessarily all objects or advantages described above may be achieved in accordance with any particular embodiment. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While the technology has been described in detail in connection with only a limited number of embodiments, it should be readily understood that the specification is not limited to such disclosed embodiments. Rather, the technology can be modified to incorporate any number of variations, alterations, substitutions or equivalent arrangements not heretofore described, but which are commensurate with the spirit and scope of the claims. Additionally, while various embodiments of the technology have been described, it is to be understood that aspects of the specification may include only some of the described embodiments. Accordingly, the specification is not to be seen as limited by the foregoing description, but is only limited by the scope of the appended claims.

1. A motor protector comprising:
a housing;
a rotatable shaft disposed within the housing;
a plurality of radial bearings coupled to the rotatable shaft, for supporting the rotatable shaft against the housing;
a thrust bearing coupled to the rotatable shaft, for supporting the rotatable shaft against the housing;
a shaft seal coupled to the rotatable shaft, and configured to seal a first portion from a second portion of the housing; and
an isolation chamber, coupled substantially lateral to the housing and configured to separate a first fluid and a second fluid via the housing.

2. The motor protector of claim 1, further comprising a first inlet coupled to the housing, for allowing a flow of the first fluid into the housing.

3. The motor protector of claim 2, further comprising a second inlet extending from the housing to the isolation chamber, for allowing the flow of the first fluid from the housing to the isolation chamber.

4. The motor protector of claim 3, further comprising a third inlet extending from the housing to the isolation chamber, for allowing the flow of the second fluid from the housing to the isolation chamber.

5. The motor protector of claim 1, wherein the isolation chamber comprises at least one of a labyrinth chamber, a bag chamber, and a metal bellow chamber.

6. The motor protector of claim 5, wherein the isolation chamber comprises at least two of the labyrinth chamber, the bag chamber, and the metal bellow chamber disposed in series.

7. The motor protector of claim 5, wherein the isolation chamber comprises at least two of the labyrinth chamber, the bag chamber, and the metal bellow chamber disposed in parallel.

8. The motor protector of claim 1, wherein the plurality of radial bearings comprises a rolling-element bearing.

9. A method for operating an electric submersible pump disposed on a subsea floor, the method comprising:
supplying electric power to a motor lubricated by motor oil;
driving a pump unit using the motor, via a rotatable shaft disposed within a housing;
directing a flow of motor oil via the housing into an isolation chamber upon expansion of the motor oil, wherein the isolation chamber is coupled substantially lateral to the housing;
directing a flow of a wellbore fluid extracted from a wellbore, via the housing to the isolation chamber; and
separating the motor oil from the wellbore fluid within the isolation chamber.

10. The method of claim 9, further comprising removing the motor oil from the isolation chamber via the housing upon contraction of the motor oil.

11. The method of claim 9, further comprising preventing contact of the wellbore fluid with the motor, using a shaft seal coupled to the rotatable shaft.

12. The method of claim 9, further comprising compensating a pressure difference between the wellbore fluid and the motor oil by directing the wellbore fluid and the motor oil to the isolation chamber via the housing.

13. The method of claim 9, further comprising limiting transmission of a thrust load from the pump unit to the motor, using a thrust bearing coupled to the rotatable shaft.

14. An electric submersible pump comprising:
a motor protector, comprising:
a housing;
a rotatable shaft mounted within the housing;
a plurality of radial bearings coupled to the rotatable shaft, for supporting the rotatable shaft against the housing;
a thrust bearing coupled to the rotatable shaft, for supporting the rotatable shaft against the housing;
a shaft seal coupled to the rotatable shaft, and configured to seal a first portion from a second portion of the housing; and
an isolation chamber coupled substantially lateral to the housing;
a motor coupled to a first portion of the rotatable shaft; and
a pump unit coupled to a second portion of the rotatable shaft, wherein the isolation chamber is configured to separate a wellbore fluid extracted form a wellbore, from motor oil received via the housing.

15. The electric submersible pump of claim 14, further comprising a first inlet coupled to the housing, for allowing a flow of the wellbore fluid into the housing.

16. The electric submersible pump of claim 15, further comprising a second inlet extending from the housing to the isolation chamber, for allowing the flow of the wellbore fluid from the housing to the isolation chamber.

17. The electric submersible pump of claim 16, further comprising a third inlet extending from the housing to the isolation chamber, for allowing a flow of the motor oil from the housing to the isolation chamber.

18. The electric submersible pump of claim 14, wherein the isolation chamber comprises at least one of a labyrinth chamber, a bag chamber, and a metal bellow chamber.

19. The electric submersible pump of claim 18, wherein the isolation chamber comprises at least two of the labyrinth chamber, the bag chamber, and the metal bellow chamber disposed in series.

20. The electric submersible pump of claim 18, wherein the isolation chamber comprises at least two of the labyrinth chamber, the bag chamber, and the metal bellow chamber disposed in parallel.

21. The electric submersible pump of claim 18, further comprising a pothead coupled to the motor and configured to withstand a pressure differential between an external pressure of subsea water and internal pressure of the motor oil.

22. The electric submersible pump of claim 18, wherein the pothead further comprises a plurality of metal contacts for coupling a plurality of electric cables to the motor.

23. The electric submersible pump of claim 22, wherein the plurality of electric cables is encapsulated using a capsule to protect the plurality of electric cables from sea water.

24. The electric submersible pump of claim 18, wherein the motor is cooled by surrounding sea water when the electric submersible pump is disposed on a seabed.

25. The electric submersible pump of claim 18, wherein the isolation chamber is configured to separate the wellbore fluid from motor oil under influence of gravity.
